(19) United States
(12) Patent Application Publication
(10) Pub. No.: US 2018/0180111 A1
(43) Pub. Date: Jun. 28, 2018

(54) OUTER HUB WEDGE CLUTCH

(71) Applicant: SCHAEFFLER TECHNOLOGIES AG & CO. KG, Herzogenaurach (DE)

(72) Inventors: Marion Jack INCE, Mount Holly, NC (US); Guihui ZHONG, Charlotte, NC (US)

(21) Appl. No.: 15/388,213

(22) Filed: Dec. 22, 2016

(51) Int. Cl. F16D 13/20; F16D 13/24

(52) U.S. Cl. CPC F16D 13/20; F16D 13/24

(57) ABSTRACT

A wedge clutch imparts a wedging effect to selectively transfer power through powertrain components. The wedge clutch includes a hub configured to rotate about an axis. The hub has a tapered surface facing the axis. A rotatable member is configured to rotate about the axis and has a groove facing away from the axis. A disk is configured to radially expand and contract about the axis. The disk has an outer surface facing the tapered surface of the hub, and an inner surface facing the groove of the rotatable member. Axial movement of the hub along the axis toward the rotatable member slides the tapered surface of the hub along the outer surface of the disk to move the inner surface of the disk toward the groove of the rotatable member to frictionally engage the hub and the rotatable member and transfer power through the wedge clutch.

### TECHNICAL FIELD

The present disclosure relates to a wedge clutch for selectively coupling two or more powertrain components to each other.

### BACKGROUND

In a motor vehicle, a four-wheel drive system or an all-wheel drive system can be selectively activated by a clutch. The clutch can be part of a power transfer unit for connecting a power source to a secondary drive shaft when it is desired to deliver power to the secondary drive shaft. It is known that such a clutch can be a dog clutch. Dog clutches are prone to teeth clash or blocking. It is also known that such a clutch can be a wet clutch in a differential. Pressurized fluid must be continuously supplied to keep the clutches in a closed mode, adding to the power usage associated with usage of the clutch. Wedge clutches are known, such as those described in U.S. Patent Publication Numbers 2015/0083539, 2015/0014113, and 2015/0152921.

### SUMMARY

According to one embodiment, a wedge clutch includes a hub configured to rotate about an axis. The hub has a tapered surface facing the axis. A rotatable member is configured to rotate about the axis and has a groove facing away from the axis. A disk is configured to radially expand and contract about the axis. The disk has an outer surface facing the tapered surface of the hub, and an inner surface facing the groove of the rotatable member. Axial movement of the hub along the axis toward the rotatable member slides the tapered surface of the hub along the outer surface of the disk to move the inner surface of the disk toward the groove of the rotatable member to frictionally engage the hub and the rotatable member.

The disk may include a plurality of disk segments arranged annularly about the axis. A retainer ring may be coupled to the disk segments to provide a biasing force to force the disk segments radially outward from the axis. The disk segments may collectively define an annular shoulder with an annular groove defined therein, and the retainer ring may be disposed in the annular groove.

The tapered hub surface may be tapered away from the axis toward the rotatable member. The disk outer surface may be correspondingly tapered away from the axis toward the rotatable member.

The hub may have an inner surface with spline surface features for spline-connecting the hub to a shaft extending along the axis while enabling axial movement of the hub along the shaft.

The rotatable member may be a ring gear having teeth disposed radially outward from the hub.

According to another embodiment, a clutch includes a first rotatable member rotatable about an axis and having an inner surface facing the axis. A second rotatable member is rotatable about the axis and has an outer surface facing the inner surface of the first rotatable member. The outer surface has a groove defined therein. A wedge plate is compressible and expandable toward and away from the axis. The wedge plate has an outer surface disposed on the inner surface of the first rotatable member. The wedge plate also has an inner surface selectively engagable with the groove to selectively engage the first rotatable member with the second rotatable member.

According to another embodiment, a wedge clutch includes a first race having an outer circumferential surface with a groove. A second race has a tapered inner circumferential surface located radially outward from the groove. The second race is translatable along an axis relative to the first race. A wedge plate is disposed radially between the inner and outer races. The wedge plate has an inner circumferential surface configured to engage with the groove and a tapered outer circumferential surface configured to engage with the tapered inner circumferential surface of the second race.

### BRIEF DESCRIPTION OF THE DRAWINGS

FIG. 1 is a side cross-sectional view of a wedge clutch for selectively coupling an input to an output, according to one embodiment.

FIG. 2A is a front plan view of a wedge plate having a plurality of wedge plate segments and a retaining ring, according to one embodiment.

FIG. 2B is an enlarged plan view of one of the wedge segments of FIG. 2A with the retaining ring removed.

FIG. 2C is a cross-sectional view of a wedge plate segment taken along line C-C of FIG. 2B.

FIG. 3 is a front cross-sectional view of the wedge clutch in an unlocked position, according to one embodiment.

FIG. 4 is a side cross-sectional view of the wedge clutch in the unlocked position, according to one embodiment.

FIG. 5 is a front cross-sectional view of the wedge clutch in a locked position, according to one embodiment.

FIG. 6 is a side cross-sectional view of the wedge clutch in the locked position, according to one embodiment.

FIG. 7 is a side cross-sectional view of a wedge clutch in a locked position, according to an alternative embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

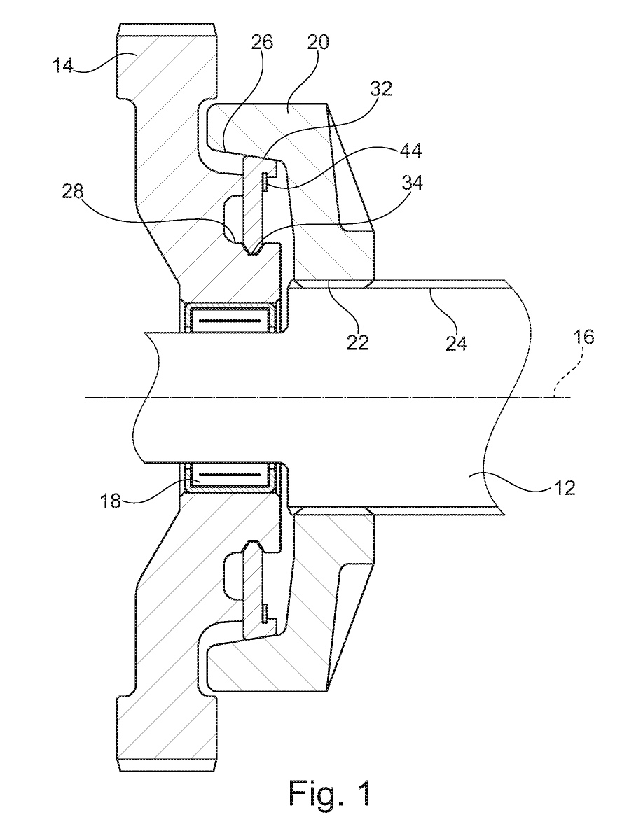

Referring to FIG. 1, a portion of a power-transfer unit (PTU) for a powertrain of an automotive vehicle is shown. The PTU may be utilized for selectively activating all-wheel drive or four-wheel drive in the automotive vehicle, for example. To selectively activate the all-wheel drive or four-wheel drive, a wedge clutch 10 is utilized. Details of the structure and operation of the wedge clutch is provided herein. Additional structure and operation of the wedge clutch is provided in the following documents, which are incorporated by reference herein: U.S. patent application Ser. No. ______ (Attorney Docket SCHF0104PUS), filed on the same day as this disclosure; U.S. patent application Ser. No. ______ (Attorney Docket SCHF0105PUS), filed on the same day as this disclosure; U.S. patent application Ser. No. ______ (Attorney Docket SCHF0106PUS), filed on the same day as this disclosure; U.S. patent application Ser. No. ______ (Attorney Docket SCHF0108PUS), filed on the same day as this disclosure; and U.S. patent application Ser. No. ______ (Attorney Docket SCHF0109PUS), filed on the same day as this disclosure.

In one embodiment, a shaft 12 acts as an input member to input torque into the wedge clutch 10 from an engine of the vehicle. To activate all-wheel drive or four-wheel drive, the wedge clutch 10 is controlled to close in order to transfer torque from the shaft 12 to an output member 14 (which may be referred to as an inner race or a first race), which is coupled to the all-wheel drive or four-wheel drive system. In one example, the output member 14 is a ring gear with external teeth that engage a corresponding gear of the all-wheel or four-wheel drive system.

Both the shaft 12 and the output member 14 may be supported by a housing for rotation about an axis 16. The output member 14 may be supported for rotation about the axis via bearing 18. When no torque is transmitted to the output member 14, the output member 14 may freely rotate about the shaft via the bearing 18 irrespective of the rotation of the shaft 12. Alternatively, when the wedge clutch 10 is closed to transmit torque to the output member 14, the output member 14 is fixed to rotate with the shaft 12, as will be described below. The output member 14 may be driveably connected to a transmission output shaft. Two components are driveably connected if they are connected by a power flow path that constrains their rotational speeds to be proportional.

The wedge clutch 10 includes a hub 20 (which may be referred to as an outer race or a second race) that is coupled to the shaft 12 via a spline connection, generally shown at 22. For example, the hub 20 may include an inner surface facing the shaft 12 that includes spline surface features that engage with corresponding spline surface features on an outer surface of the shaft 12. While fixing the hub 20 and the shaft 12 radially with respect to one another, the spline connection also enables relative axial movement of the hub 20 relative to the outer surface of the shaft 12.

The hub 20 includes an inner surface 26 that circumferentially extends about the axis 16 and faces the axis 16. Likewise, the output member 14 includes an outer surface 28 that circumferentially extends about the axis 16 and faces the inner surface 26. A wedge plate 30 is disposed between the inner surface 26 and the outer surface 28. The wedge plate 30 may be an annular disk or a group of separable disks segments connected together. As will be described below in greater detail, the wedge plate 30 includes an outer surface 32 facing away from the axis 16 that is slideably disposed on the inner surface 26, and an inner surface 34 facing toward the axis 16 that is configured to move into an out of engagement with the outer surface 28 of the output member 14. When the inner surface 34 of the wedge plate 30 engages the inner, angled surface of the groove 50 of the output member 14, the clutch may be closed and torque may be transmitted through the wedge clutch 10; when the inner surface 34 of the wedge plate 30 is spaced from or disengaged from the groove 50 of the output member 14, the clutch may be open and the torque may not be transmitted through the wedge clutch 10. It should be noted that in one embodiment, the wedge plate 30 and the groove 50 are shaped such that the inner surface 34 of the wedge plate is only able to contact the angled surfaces of the groove 50 but not other portions of the outer surface 28 of the output member 14.

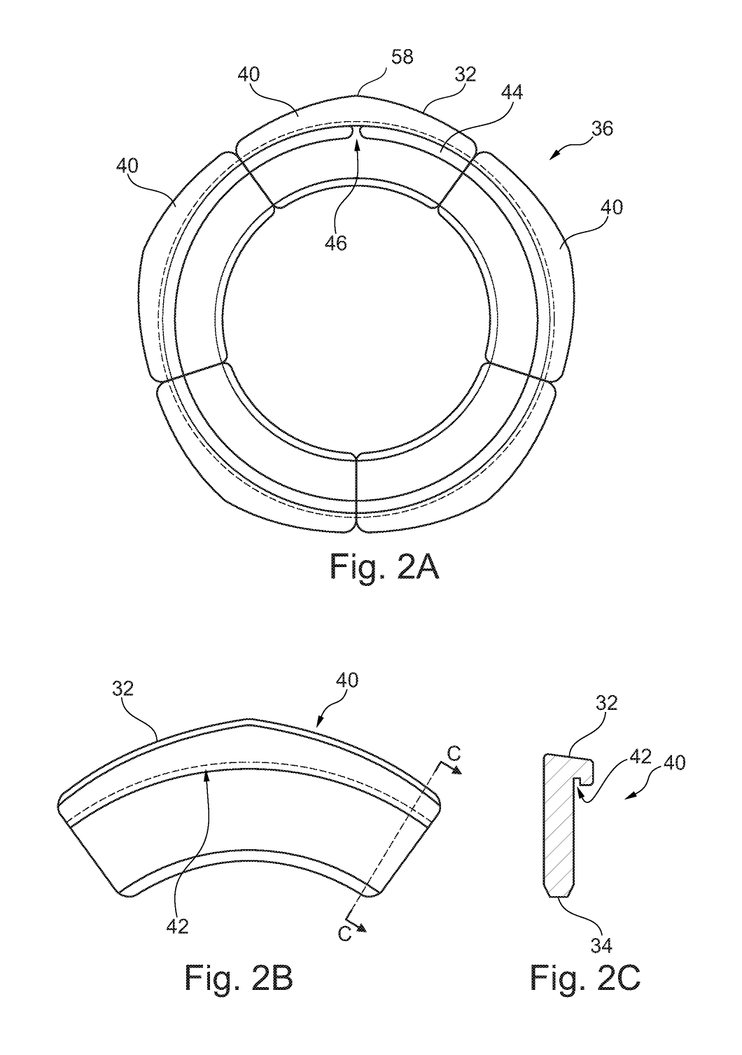

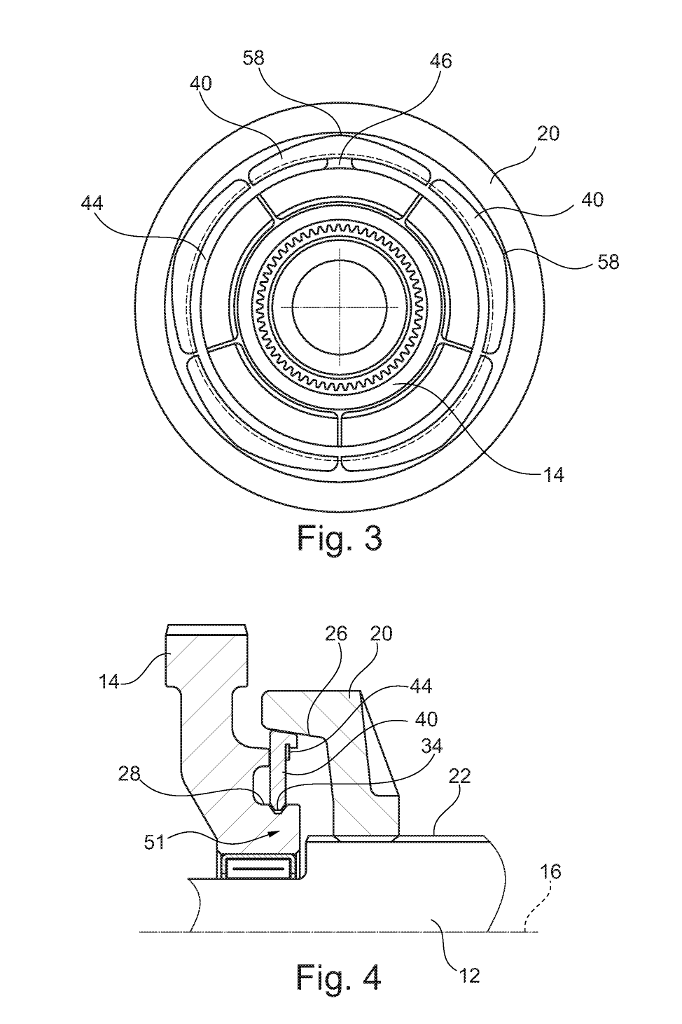

FIGS. 2A-2C show the wedge plate 30 and portions thereof. In one embodiment, the wedge plate 30 is a single plate with no separate segments. Alternatively, in the illustrated embodiment, the wedge plate 30 includes a plurality of individual wedge plate segments 40. In this embodiment, five wedge plate segments 40 are illustrated, but more or less than five may be included in the wedge plate. Each segment 40 includes a groove 42 defined therein sized to receive an annular retaining ring 44. The retaining ring 44 couples the segments 40 to one another and is biased with a spring force to press the segments 40 outward against the inner surface 26 of the hub 20 away from the axis 16. The retaining ring 44 is split to define a gap between two ends at 46 to allow expansion and contraction of the wedge plate 30, and separation of the wedge plate segments 40 from one another as shown in FIG. 3 described below.

The outer surface 32 of the wedge plate 30, or the outer surface of each wedge plate segment 40, is tapered. As shown in FIG. 1, the outer surface 32 is tapered inward (e.g., toward the axis 16) as the outer surface 32 extends towards the front of the hub 20. The inner surface 26 of the hub 20 is also tapered to match the profile of the tapered outer surface 32 of the wedge plate. This facilitates sliding of the outer surface 32 of the wedge plate 30 along the inner surface 26 of the hub 20. As will be described in further detail below, sliding of the hub 20 in one direction (e.g., to the left as viewed in FIG. 1) along the wedge plate 30 compresses the wedge plate segments 40 inward to engage with the outer surface 28 of the output member 14 to lock the clutch 10; sliding of the hub 20 in the other direction (e.g., to the right as viewed in FIG. 1) along the wedge plate 30 enables the retaining ring 44 to press the wedge plate segments 40 outward and away from the outer surface 28 of the output member 14 to unlock the clutch 10.

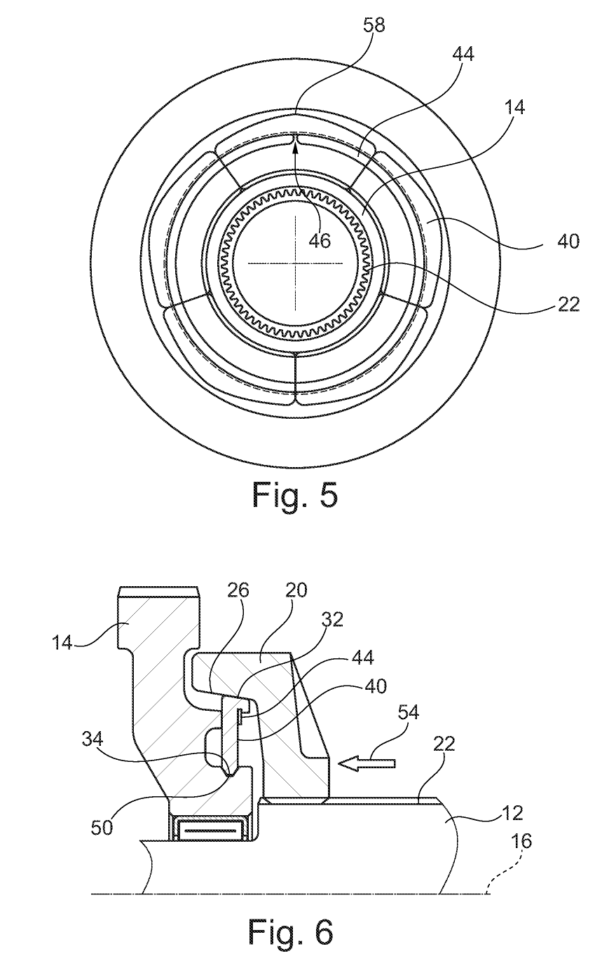

Locking and unlocking of the wedge clutch 10 will now be described with reference to FIGS. 3-6, which include the structure described above and shown in FIGS. 1 and 2A-2C. FIGS. 3 and 4 show the clutch 10 in its unlocked position in which torque or power does not transmit to the output member 14. FIGS. 5 and 6 show the clutch 10 in its locked position in which torque or power is able to transmit from the shaft 12 to the output member 14.

In the unlocked position illustrated in FIGS. 3 and 4, the hub 20 is disposed along the shaft 12 at a first linear position separated from the output member 14 by a first linear distance. The wedge plate segments 40 are radially expanded outward from the axis 16 via a biasing force from the retaining ring 44. When the retaining ring 44 is biased outward, a gap 46 may exist between the two ends of the retaining ring 44. The biasing of the retaining ring 44 causes the outer surface 32 of the wedge plate segments 40 to press against the inner surface 26 of the hub 20, and away from the outer surface 28 of the output member 14. The outer surface 28 of the output member 14 may be on a shoulder 51 having a groove 50 defined therein. The groove 50 may be tapered or otherwise shaped to match the shape of the inner surface 34 of the wedge plate segments 40. In the unlocked position, the inner surface 34 of the wedge plate segments 40 is spaced from the groove 50, thereby preventing torque from transmitting from the hub 20 to the output member 14 via the wedge plate 30.

In the locked position illustrated in FIGS. 5 and 6, the hub 20 is translated to be disposed along the shaft 12 at a second linear position separated from the output member 14 by a second linear distance less than the first linear distance. From the perspective of the views of FIGS. 5 and 6, the hub 20 has moved toward the left. This can be accomplished by an actuator (e.g., electromechanical) that provides an actuation force, or by rotating the shaft 12 circumferentially with respect to the hub 20. These and other embodiments for forcing the hub 20 along the shaft 12 can be represented by a force arrow 54, which translates the hub 20 along the spline connection (e.g., to the left). This movement of the hub 20 causes the tapered outer surface 32 of the wedge plate segments 40 to slide along the tapered inner surface 26 of the hub 20, thereby compressing the wedge plate segments 40 inward toward the axis 16. The wedge plate segments 40 being compressed inward can cause the retaining ring 44 to also compress or constrict, to shrink the size of the gap 46. Furthermore, the wedge plate segments 40 may touch one another along their side surfaces, or at least be closer to one another than when in the unlocked position.

When the hub 20 has moved a sufficient distance along the shaft 12, the inner surface 34 of the wedge plate segments 40 is pressed radially inward into and against the groove 50 of the output member 14. This allows torque or power to be transferred from the wedge plate segments 40 to the output member 14 at the interface of the inner surface 34 and the groove 50. The transfer of torque to the output member 14 causes the output member 14 to increase in speed to match that of the hub 20. Once the speeds of the output member 14 and the hub 20 are matched, the clutch is considered to be locked.

The outer surface 32 of each wedge segment 40 may also be provided with a cam surface 58 with an apex. In other words, the outer surface 32 may be tapered circumferentially such that an apex of the cam surface (indicated at 58) is located radially outward from the remainder of the outer surface 32. This cam surface 58 engages with a corresponding cam receptacle formed in the inner surface 26 of the hub 20. In other words, the inner surface 26 may be tapered circumferentially similar to the circumferential taper of the outer surface 32 of the wedge segments. As explained above, when the hub 20 slides axially to lock the wedge clutch, the wedge segments 40 are compressed into the groove 50 of the rotatable member 14. When pressed into the groove 50, the wedge segments 40 are biased to or may attempt to move with the rotatable member 14, but the hub 20 does not. The circumferential tapers and cam surface 58 force the wedge segments 58 to rotate about the axis with respect to the hub 20 as the hub 20 moves axially. As the wedge segments 40 rotate relative to the hub 20, the circumferential tapers compress the wedge plate further into the groove 50 to hold a higher amount of torque than the axial displacement alone. When in the locked position, each cam surface 58 is wedged within a respective cam receptacle. This inhibits rotation of the wedge plates with respect to the hub 20 when the wedge plate is locked. The inner surface 26 of the hub 20 removes lash from the wedge clutch system and the cam surface 58 creates a wedge effect to lock or couple the powertrain components to transfer power.

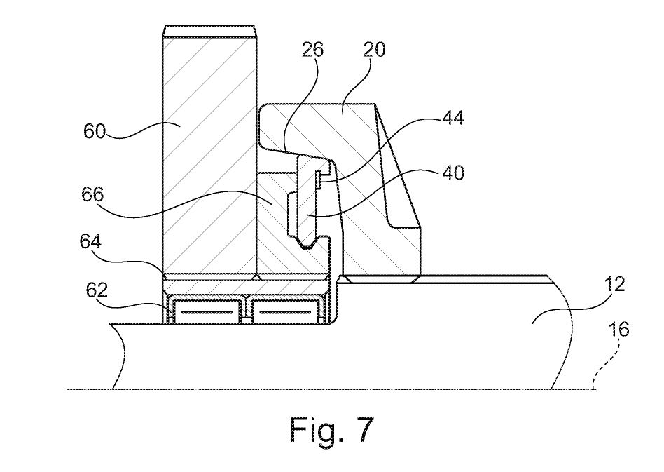

FIG. 7 illustrates another embodiment of a wedge clutch that can be retrofitted to an existing output member (e.g., ring gear) of the vehicle. The wedge clutch of FIG. 7 has some overlapping similarities in structure as that of FIGS. 1-6, and in such circumstances, the same reference number is provided. Only the differences between FIG. 7 compared to FIGS. 1-6 are described herein. An existing output member 60 is illustrated that may be part of an existing driveline. The output member 60 is spline-fitted to a bearing 62 at a spline shaft 64 that extends about the bearing. A locking ring 66 is spline-fitted to the common spline shaft 64 to rotate about the bearing 62 (which may be a double-bearing arrangement). The locking ring is provided with the groove 50 that selectively interfaces with the inner surface 34 of the wedge segments 40. In this embodiment, the locking ring 66, wedge plate segments 40, and hub 20 can be assembled to an existing shaft and output member 60 to retrofit the wedge clutch.

It should also be understood that the relative radial locations of the hub and the output member may be swapped, such that the hub includes a groove on its outer surface for engagement with the wedge plate, and the output member includes a tapered inner surface for sliding engagement with the wedge plate. In such an embodiment, the output member can be translatable along the axis and the hub can be fixed to the shaft.

The wedge clutch described in the various embodiments above is designed to combat centrifugal force. More specifically, implementing a taper on the outer surface of the wedge plate and the groove on the outer surface of the hub (as opposed to having a taper on the inner surface of the wedge plate and the groove on an inner surface of the hub) can inhibit unintentional lock-up which could otherwise be caused by centrifugal force of the spinning components forcing the wedge plate outward into engagement with the groove. The retainer ring is biased to press the wedge plate segments radially outward even without the presence of a centrifugal force.

The wedge clutch described in the various embodiments also improves torque capabilities. Having the taper on the inner surface (as opposed to the outer surface) of the wedge plate has a potential to limit torque capabilities due to the inner surface of the wedge plate segments being an area of high stress. Moving the taper to the outer surface of the wedge plate segments creates a larger circumference and surface area of engagement between the wedge plate segments and the groove, making it possible to carry higher torque under the same contact force at the same stress level.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A clutch comprising:
a hub configured to rotate about an axis and having a tapered hub surface facing the axis;
a rotatable member configured to rotate about the axis and having a rotatable member groove facing away from the axis; and
a disk configured to radially expand and contract about the axis, the disk having a disk outer surface facing the tapered hub surface and a disk inner surface facing the rotatable member groove;
wherein an axial movement of the hub along the axis toward the rotatable member slides the tapered hub surface along the disk outer surface to move the disk inner surface toward the rotatable member groove to frictionally engage the hub and the rotatable member.

2. The clutch of claim 1, wherein the disk comprises a plurality of disk segments arranged annularly about the axis.

3. The clutch of claim 2, further comprising a retainer ring coupled to the disk segments and biased to force the disk segments radially outward from the axis.

4. The clutch of claim 3, wherein the disk segments collectively define an annular shoulder with an annular groove defined therein, and the retainer ring is disposed in the annular groove.

5. The clutch of claim 2, wherein the tapered hub surface is tapered circumferentially, and the disk segments each include an outer surface tapered circumferentially such that the axial movement of the hub along the axis forces the disk segments to rotate with respect to the hub.

6. The clutch of claim 1, wherein the tapered hub surface is tapered away from the axis toward the rotatable member.

7. The clutch of claim 1, wherein the hub has an inner surface with spline surface features for spline-connecting the hub to a shaft extending along the axis while enabling axial movement of the hub along the shaft.

8. The clutch of claim 1, wherein the rotatable member is a ring gear having teeth disposed radially outward from the hub.

9. A clutch comprising:
a first rotatable member rotatable about an axis and having an inner surface facing the axis;
a second rotatable member rotatable about the axis and having an outer surface facing the inner surface of the first rotatable member, the outer surface having a groove defined therein; and
a wedge plate compressible and expandable toward and away from the axis, the wedge plate having
an outer surface disposed on the inner surface of the first rotatable member, and
an inner surface selectively engagable with the groove to selectively engage the first rotatable member with the second rotatable member.

10. The clutch of claim 9, wherein the inner surface of the first rotatable member and the outer surface of the wedge plate are axially tapered.

11. The clutch of claim 9, wherein the inner surface of the first rotatable member and the outer surface of the wedge plate are circumferentially tapered.

12. The clutch of claim 9, wherein axial movement of the first rotatable member with respect to the second rotatable member slides the inner surface of the first rotatable member along the outer surface of the wedge plate to force the wedge plate to compress toward the axis.

13. The clutch of claim 12, wherein compression of the wedge plate wedges the inner surface into the groove to frictionally engage with the groove.

14. The clutch of claim 9, wherein the first rotatable member is axially translatable along a shaft and the second rotatable member is axially fixed with respect to the shaft.

15. The clutch of claim 9, wherein the wedge plate comprises a plurality of individual wedge segments bound together by a retainer ring biasing the wedge segments radially outward from the axis.

16. A wedge clutch, comprising:
a first race having an outer circumferential surface with a groove;
a second race having a tapered inner circumferential surface located radially outward from the groove, the second race being translatable along an axis relative to the first race; and
a wedge plate disposed radially between the inner and outer races, the wedge plate having an inner circumferential surface configured to engage with the groove and a tapered outer circumferential surface configured to engage with the tapered inner circumferential surface of the second race.

17. The wedge clutch of claim 16, wherein axial translation of the second race forces the tapered inner circumferential surface of the second race to slide along the tapered outer circumferential surface of the wedge plate.

18. The wedge clutch of claim 17, wherein the axial translation in one direction forces the inner circumferential surface of the wedge plate radially inward and into the groove.

19. The wedge clutch of claim 16, wherein the wedge plate comprises a plurality of wedge plate segments arranged annularly about the axis, the wedge clutch further comprising a retainer ring coupled to the wedge plate segments and biased to force the wedge plate segments radially outward from the axis.

20. The wedge clutch of claim 16, wherein no torque is transmitted from the second race to the first race when the inner circumferential surface of the wedge plate is spaced from the groove.
